(19) United States
(12) Patent Application Publication
(10) Pub. No.: US 2008/0146252 A1
(43) Pub. Date: Jun. 19, 2008

(54) TANDEM TRANSMISSION OF DATA OVER SIGNALING AND PAGING

(76) Inventors: Ashu RAZDAN, San Diego, CA (US); Eric C. ROSEN, Solana Beach, CA (US)

Correspondence Address: QUALCOMM INCORPORATED, 5775 MOREHOUSE DR., SAN DIEGO, CA, 92121, US

(21) Appl. No.: 11/609,981

(22) Filed: Dec. 13, 2006

(51) Int. Cl. H04Q 7/20

(52) U.S. Cl. 455/458

(57) ABSTRACT

Systems and methods for improving data delivery latency in a wireless communication system are disclosed. The method and system can include transmitting a data over signaling (DOS) message to an access terminal in a first portion of a paging zone estimated to contain the access terminal and paging the access terminal in other portions of the paging zone.

### BACKGROUND OF THE INVENTION

1. Field

The present invention generally relates to communication systems. More particularly, the invention relates to paging and signaling in wireless communication systems to improve data delivery latencies.

2. Background

Wireless communication systems have developed through various generations, including a first-generation analog wireless phone service (1G), a second-generation (2G) digital wireless phone service (including interim 2.5G and 2.75G networks) and a third-generation (3G) high speed data/Internet-capable wireless service. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Time Division Multiple Access (TDMA), the Global System for Mobile access (GSM) variation of TDMA, and newer hybrid digital communication systems using both TDMA and CDMA technologies.

The method for providing CDMA mobile communications was standardized in the United States by the Telecommunications Industry Association/Electronic Industries Association in TIA/EIA/IS-95-A entitled “Mobile Station-Base Station Compatibility Standard for Dual-Mode Wideband Spread Spectrum Cellular System,” referred to herein as IS-95. Combined AMPS & CDMA systems are described in TIA/EIA Standard IS-98. Other communications systems are described in the IMT-2000/UM, or International Mobile Telecommunications System 2000/Universal Mobile Telecommunications System, standards covering what are referred to as wideband CDMA (WCDMA), CDMA2000 (such as CDMA2000 1xRTT, “1x”, and 1xEV-DO standards, “1xEV”, for example) or TD-SCDMA.

In wireless communication systems, mobile stations or access terminals receive signals from fixed position base stations that support communication links or services within particular geographic regions adjacent to or surrounding the base stations. One or more of these base stations can be organized into a group referred to as a cell. In order to aid in providing coverage, each cell is often sub-divided into multiple sectors, each corresponding to a smaller service area or geographic region. An array or series of base stations placed adjacent to each other form a communication system capable of servicing a number of system users, over a larger region. Generally, a paging zone is formed of a group of cells over a large geographic area.

Typically, each mobile station monitors a control channel that is used to transmit system/overhead messages/pages, whereas traffic channels are typically used for substantive communication (e.g., voice and data) to and from the mobile station. For example, the control channel can be used to establish traffic channels, control power levels, and the like, as is known in the art. However, before a traffic channel can be established, typically an access terminal is paged first so that the location of the access terminal and associated base station can be located.

However, paging an access terminal can still result in significant delays for latency sensitive data. For example, access terminals are not required to update their locations when the access terminal moves from base station to base station in a cell/paging zone. Accordingly, the wireless network typically does not know where the access terminal is when latency sensitive data needs to be sent to the access terminal. Using conventional paging techniques, the data delivery will be delayed until the access terminal is paged, responds and a traffic channel is established. This delay may be unacceptable for some latency sensitive applications.

To address the potential delay due to paging, another conventional method sends a data over signaling (DOS) message to the last base station used by the access terminal. This method can be effective as the data is directly sent over a common channel, but is also bandwidth intensive. Further, using this method, if the message transmission is unsuccessful the system waits for a time out at the application layer, before the data is retransmitted.

Conventional methods and systems are subject to delays in sending latency sensitive data to mobile terminals/access terminals. Accordingly, it would be beneficial to provide improved methods and systems for sending latency sensitive data to access terminals in a wireless communication system.

### SUMMARY OF THE EXEMPLARY EMBODIMENTS

Exemplary embodiments of the present invention are directed to systems and methods for improved data delivery latencies in wireless communication systems.

Accordingly, at least one embodiment of the invention can include a method for reducing latency in a wireless communication system, the method comprising: transmitting a data over signaling (DOS) message to an access terminal in a first portion of a paging zone estimated to contain the access terminal; and

paging the access terminal in other portions of the paging zone.

Other embodiments of the invention can include a method for reducing latency in a wireless communication system, the method comprising: generating a message for delivery via the wireless communication system; and sending the message to the wireless communication system, wherein the message includes a request to send a data over signaling (DOS) message and page to an access terminal.

Other embodiments of the invention can include an apparatus comprising: logic configured to generate a message for delivery via a wireless communication system; and logic configured to send the message to the wireless communication system, wherein the message includes a request to send a data over signaling (DOS) message and page to an access terminal.

Other embodiments of the invention can include a system comprising: means for generating a message for delivery via a wireless communication system; and means for sending the message to the wireless communication system, wherein the message includes a request to send a data over signaling (DOS) message and page to an access terminal.

Other embodiments of the invention can include a computer readable media embodying a method for reducing latency in a wireless communication system, the method comprising: transmitting a data over signaling (DOS) message to an access terminal in a first portion of a paging zone estimated to contain the access terminal; and paging the access terminal in other portions of the paging zone.

### BRIEF DESCRIPTION OF THE DRAWINGS

A more complete appreciation of embodiments of the invention and many of the attendant advantages thereof will be readily obtained as the same becomes better understood by reference to the following detailed description when considered in connection with the accompanying drawings which are presented solely for illustration and not limitation of the invention, and in which:

FIG. 1 is a diagram of a wireless network architecture that supports access terminals and access networks in accordance with at least one embodiment of the invention.

FIG. 2 is an illustration of an access terminal in accordance with at least one embodiment of the invention.

FIG. 3 is an illustration of a portion of a paging zone and elements thereof in accordance with at least one embodiment of the invention.

FIG. 4 is a flowchart illustrating methods in accordance with at least one embodiment of the invention.

FIG. 5 is an illustration of a wireless network architecture that supports access terminals and access networks in accordance with at least one embodiment of the invention.

FIG. 6 is an illustration of a group communication network in accordance with at least one embodiment of the invention.

### DETAILED DESCRIPTION OF THE PREFERRED EMBODIMENTS

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

A High Data Rate (HDR) subscriber station, referred to herein as an access terminal (AT), may be mobile, and may communicate with one or more HDR base stations, referred to herein as modem pool transceivers (MPTs) base station transceivers (BTS), base stations (BS) or more generally as access points. An access terminal transmits and receives data packets through one or more modem pool transceivers to an HDR base station controller, referred to as a modem pool controller (MPC), base station controller (BSC) and/or mobile switching center (MSC). These elements are parts of a network called an access network or radio access network (RAN). An access network transports data packets between multiple access terminals. The access network may be further connected to additional networks outside the access network, such as a corporate intranet or the Internet, and may transport data packets between each access terminal and such outside networks. An access terminal that has established an active traffic channel connection with one or more access points is called an active access terminal, and is said to be in a traffic state. An access terminal that is in the process of establishing an active traffic channel connection with one or more access points is said to be in a connection setup state.

An access terminal may be any data device that communicates through a wireless channel and/or through a wired channel, for example using fiber optic or coaxial cables. An access terminal may further be any of a number of types of devices including but not limited to PC card, compact flash, external or internal modem, or wireless or wireline phone. The communication link through which the access terminal sends signals to the access point is called a reverse link or traffic channel. The communication link through which an access point sends signals to an access terminal is called a forward link or traffic channel. As used herein the term traffic channel can typically refer to either a forward or reverse traffic channel.

Additionally, although exemplary embodiments of the invention are described in terms of a wireless system and specific technologies such as CDMA 1x and 1xEV system, those skilled in the art will appreciate that the invention is not limited to the illustrated systems. For example, embodiments of the invention can include any system that can use paging and data over signaling (DOS) techniques.

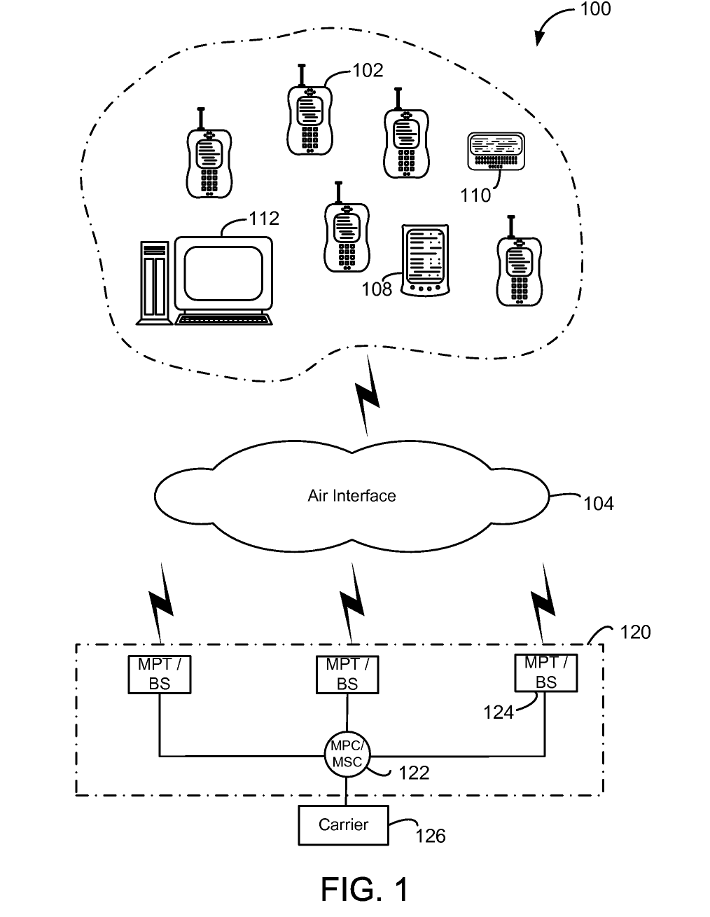

FIG. 1 illustrates a block diagram of one exemplary embodiment of a wireless system 100 in accordance with at least one embodiment of the invention. System 100 can contain access terminals, such as cellular telephone 102, in communication across an air interface 104 with an access network or radio access network (RAN) 120 that can connect the access terminal 102 to network equipment providing data connectivity between a packet switched data network (e.g., an intranet, the Internet, and/or carrier network 126) and the access terminals 102, 108, 110, 112. As shown here, the access terminal can be a cellular telephone 102, a personal digital assistant 108, a pager 110, which is shown here as a two-way text pager, or even a separate computer platform 112 that has a wireless communication portal. Embodiments of the invention can thus be realized on any form of access terminal including a wireless communication portal or having wireless communication capabilities, including without limitation, wireless modems, PCMCIA cards, personal computers, telephones, or any combination or sub-combination thereof. Further, as used herein, the terms “access terminal”, “wireless device”, “client device”, “mobile terminal” and variations thereof may be used interchangeably. Further as used herein the terms “access point”, “modem pool transceiver (MPT)”, “base transceiver station (BTS)”, “base station (BS)” and like variations thereof may be used interchangeably.

Referring back to FIG. 1, the components of the wireless network 100 and interrelation of the elements of the exemplary embodiments of the invention are not limited to the configuration illustrated. System 100 is merely exemplary and can include any system that allows remote access terminals, such as wireless client computing devices 102, 108, 110, 112 to communicate over-the-air between and among each other and/or between and among components connected via the air interface 104 and RAN 120, including, without limitation, carrier network 126, a core network, the Internet, and/or other remote servers.

The RAN 120 controls messages (typically sent as data packets) sent to a MPC/MSC 122. The carrier network 126 may communicate with the MPC/MSC 122 by a network, the Internet and/or a public switched telephone network (PSTN). Alternatively, the MPC/MSC 122 may connect directly to the Internet or external network. Typically, the network or Internet connection between the carrier network 126 and the MPC/MSC 122 transfers data, and the PSTN transfers voice information. The MPC/MSC 122 can be connected to multiple base stations (BS) or modem pool transceivers (MPT) 124. In a similar manner to the carrier network, the MPC/MSC 122 is typically connected to the MPT/BS 124 by a network, the Internet and/or PSTN for data transfer and/or voice communication. The MPT/BS 124 can broadcast data messages wirelessly to the access terminals, such as cellular telephone 102. The MPT/BS 124, MPC/MSC 122 and other components may form the RAN 120, as is known in the art.

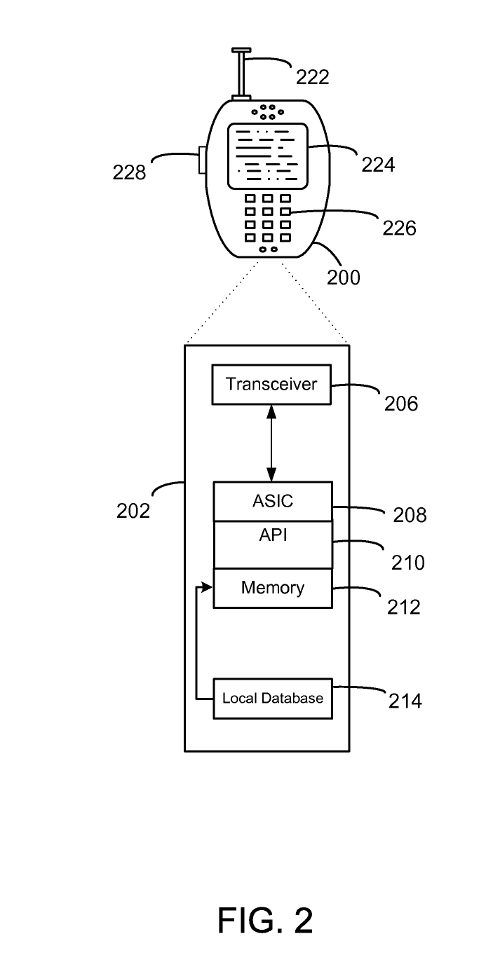

Referring to FIG. 2, the access terminal 200, (here a wireless device), such as a cellular telephone, has a platform 202 that can receive and execute software applications, data and/or commands transmitted from the RAN 120 that may ultimately come from the carrier network 126, the Internet and/or other remote servers and networks. The platform 202 can include a transceiver operably coupled to an application specific integrated circuit (“ASIC” 208), or other processor, microprocessor, logic circuit, or other data processing device. The ASIC 208 or other processor can execute the application programming interface (“API”) 210 layer that may interface with any resident programs in the memory 212 of the wireless device. The memory 212 can be comprised of read-only or random-access memory (RAM and ROM), EEPROM, flash cards, or any memory common to computer platforms. The platform 202 also can include a local database 214 that can hold applications/data not actively used in memory 212. The local database 214 is typically a flash memory cell, but can be any secondary storage device as known in the art, such as magnetic media, EEPROM, optical media, soft or hard disk, and the like. The internal platform 202 components can also be operably coupled to external devices such as antenna 222, display 224, push-to-talk button 228 and keypad 226 among other components, as is known in the art.

Accordingly, aspects of the invention may include an access terminal including the ability to perform the functions described herein. As will be appreciated by those skilled in the art, the various logic elements can be embodied in discrete elements, software modules executed on a processor or any combination of software and hardware to achieve the functionality disclosed herein. For example, ASIC 208, memory 212, API 210 and local database 214 may all be used cooperatively to load, store and execute the various functions disclosed herein and thus the logic to perform these functions may be distributed over various elements. Alternatively, the functionality could be incorporated into one discrete component. Therefore, the features of the access terminal in FIG. 2 are to be considered merely illustrative and the invention is not limited to the illustrated features or arrangement.

As used herein “access terminal” includes, for example, one or more processing circuits executing resident configured logic, where such computing devices include, for example, microprocessors, digital signal processors (DSPs), microcontrollers, or any suitable combination of hardware, software and/or firmware containing processors and logic configured to at least perform the operations described herein. Some examples of access terminals or wireless devices which may be used in accordance with embodiments of the present invention include cellular telephones or other wireless communication units, personal digital assistants (PDAs), paging devices, handheld navigation devices, handheld gaming devices, music or video content download units, and other like wireless communication devices.

The wireless communication between the access terminal 102 and the RAN 120 can be based on different technologies, such as code division multiple access (CDMA), time division multiple access (TDMA), frequency division multiple access (FDMA), the Global System for Mobile Communications (GSM), or other protocols that may be used in a wireless communications network or a data communications network. The data communication is typically between the client device 102, MPT/BS 124, and MPC/MSC 122. The MPC/MSC 122 can be connected to multiple data networks such as the carrier network 126, PSTN, the Internet, a virtual private network, and the like, thus allowing the access terminal 102 access to a broader communication network. As discussed in the foregoing and known in the art, voice transmission and/or data can be transmitted to the access terminals from the RAN 120.

As discussed in the background, paging can be used to notify an access terminal (e.g., a wireless device) that a communication directed to that terminal is available. Typically, the access terminal monitors a non-traffic channel (e.g., control channel) to check for paging directed to the access terminal. However, the paging and traffic channel setup process can lead to unacceptable delays in latency sensitive applications. Further, using a scheme (e.g., data over a signaling channel) such as described in the background could backfire in cases where the access terminal starts receiving service from a new base station leaving the coverage of the previous base station (also known as idle handoff). The access terminal is normally required to send a route update message notifying the RAN (e.g., BSC) of a handoff only when paging zones/boundaries are crossed. Since data over signaling is costly (in terms of bandwidth) and the messages are conventionally not flooded in the entire paging zone, the access terminal might not receive the message in the case of an idle handoff. In such cases the system waits for the application layer to time out and then retransmits that data, which causes further delays.

Accordingly, embodiments of the invention provide methods and systems for sending a data over signaling (DOS) message to the BTS that the RAN (e.g., BSC or other controller) estimates is serving the access terminal and also flood pages for the same access terminal in the rest of the paging zone (e.g., to the other BTSs). Thus, embodiments of the invention ensure that in the event that the access terminal has performed an idle handoff to a different base station within the same paging zone, the data to be delivered can be sent over the traffic channel instead. Using embodiments of the invention, the BSC need not wait for a round trip time (e.g., ˜300 ms) before it can retry delivering the data, which can significantly reduce latency. Additional details and examples are provided in the following sections to further illustrate the embodiments of the invention.

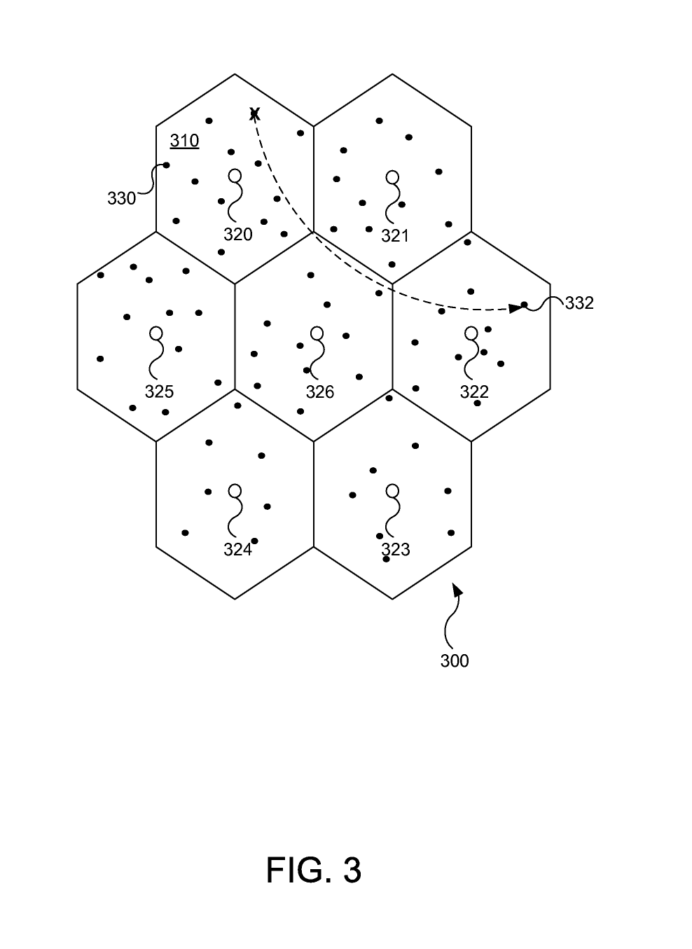

Referring to FIG. 3, for example a representative paging zone 300 is illustrated. A number of cells (e.g., 310), base stations (e.g., 320-326) and access terminals (e.g., 330 and 332) are provided for illustration only and embodiments of the invention are not limited to this configuration. For example, referring to base station 320, if the RAN or other system determines (e.g., based on prior communications) that both access terminal 330 and 332 are in the service area of base station 320, then a DOS message for access terminal 330 and a DOS message for access terminal 332 will be sent to base station 320. The DOS message for access terminal 320 will be successful because, as illustrated, access terminal 320 is still serviced by base station 320. However, the DOS message for access terminal 332 will not be successfully received because access terminal 332 has moved to a sector serviced by base station 322. In contrast to conventional systems, instead of only resulting in a failure and waiting for a time out, embodiments of the invention cause pages to be sent from base stations 321-326 for both access terminals 330 and 332. Accordingly, access terminal 332 will receive the page, but not its DOS message and will proceed to establish a traffic channel to receive the data.

From the foregoing example, those skilled in the art will appreciate that providing the DOS message to an access terminal results in the minimum delay for the system. However, additionally sending a page for access terminal 332 on the other base stations 321-326, prevents the significant delay penalty due to a failed DOS message. Further, although pages were sent for access terminal 330 on base stations 321-326 these do not significantly impact system loading and do not pose an operational problem as a response can be received from access terminal 330 in response to the DOS message.

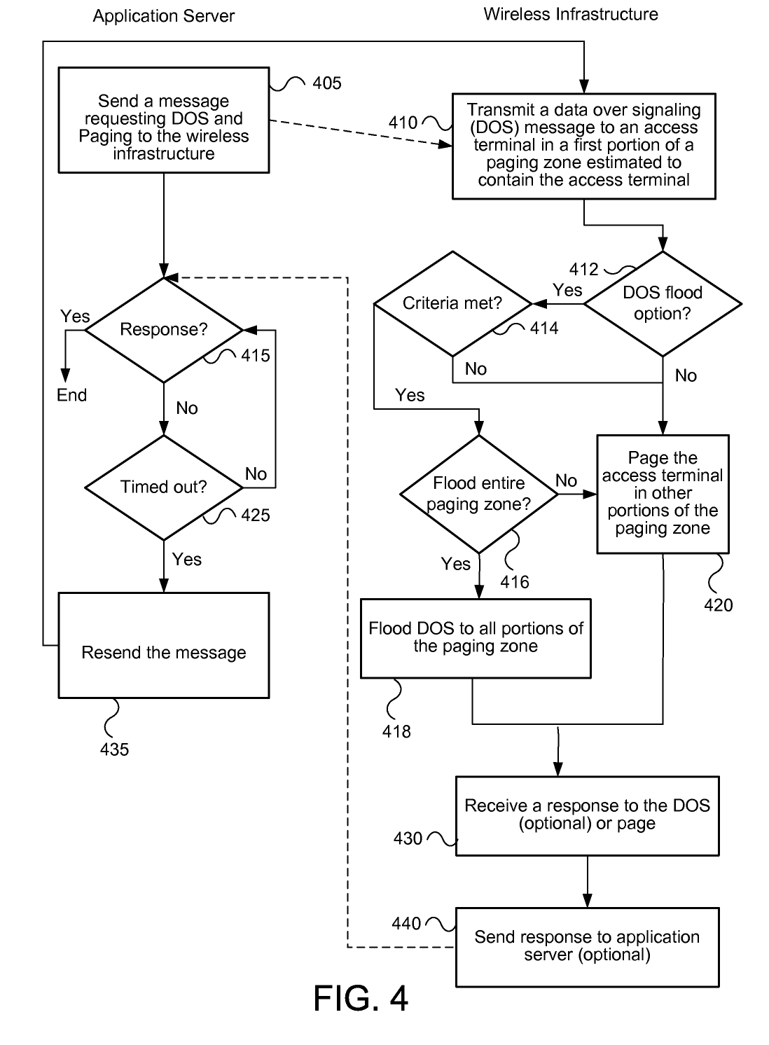

From the foregoing description, those skilled in the art will appreciate that embodiments of the invention can include methods for performing the sequence of actions, functions, algorithms and/or processes describe herein. Accordingly an embodiment of the invention can include a method for reducing latency in a wireless communication system. Referring to FIG. 4, the method can include transmitting a data over signaling (DOS) message to an access terminal in a first portion of a paging zone estimated to contain the access terminal, 410, and paging the access terminal in other portions of the paging zone, 420. Typically, the paging zone is defined by system operators/engineers to cover specific geographical regions. However, as used herein, the term paging zone is not limited to any specific geographic configuration or adjacent series of cells. The paging zone can be any configuration designated by a system operator. Further, the paging zone may differ than a paging zone used for conventional paging. For example, the paging zone may include one or more conventional paging zones or portions of one or more conventional paging zones (e.g., a geographic region centered on the last location of the access terminal). Further, the term “other portions of the paging zone” does not require that all portions or sectors of the paging zone receive a page.

The first portion (e.g., a sector) of the paging zone can be determined by the last known location of the access terminal (e.g., based on the last communication from the access terminal). Alternatively, other methods for determining the first portion can be used. The DOS message and paging can be generated in response to a message sent from an application server (e.g., 405). The application server may be any device operably connected to the wireless communication system. In one embodiment, the application server can be a group communication server and the message sent can be used to establish a group call. The message sent from the application server can include information to direct the wireless communication system to send both the DOS message and paging for the access terminal. For example, the message sent from the application server can be sent in an Internet Protocol (IP) compatible format and the information can be included in a Type of Service (TOS) field.

Further, if needed, the wireless infrastructure can receive a response to at least one of the DOS message and pages sent to the access terminal, 430. As will be appreciated by those skilled in the art, the response may vary depending on whether the DOS or a page was received. For example, if the DOS message was received, the access terminal can act upon the data received in the DOS message. However, if only a page was received, the access terminal will typically acknowledge the page/setup a traffic channel to receive the data. Also, if needed, the wireless infrastructure can send the response to a source (e.g. the application server) that generated the request to send the DOS message and paging, 440. If the application server is expecting a response, 415, a time out function, 425, can be established to prevent excessive delay. If the response is not received within the time allocated, then the process can repeat and the DOS message and paging request can be resent, 435. Alternatively, other processing can be activated such as failure notification and the like as is known in the art.

Those skilled in the art will appreciate many variations to the embodiments described above. For example, an application server or other device operably coupled to the wireless communication system/wireless infrastructure can generate and send a message to the wireless communication system, where the message includes a request to send a data over signaling (DOS) message and page to an access terminal, 405. The DOS message can be transmitted to the access terminal in a first portion of a paging zone estimated to contain the access terminal, 410. Additionally, the DOS message can be transmitted to other portions of the paging zone, upon activation of a DOS flood option (412, 414). If the flooding option does not flood the entire paging zone 416, the access terminal can be paged in portions of the paging zone not receiving the DOS message, 420. For example, a system operator may limit the flooding option to a certain geographic region around the last known sector the access terminal was in and then paging can be used for sectors not covered by the flooding option. However, if the DOS flood option is for the entire paging zone, 416, then the DOS is flooded to all portions, 418, and paging is not required.

Those skilled in the art will appreciate that embodiments of the invention are not limited to the sequences described herein. For example, the system operator may define the first portion to be a last known sector and a geographic area around this sector as the first portion and use only block 410 and 420, and the flood option may be considered an adjustment to define the first portion of the paging zone.

Further, as will be appreciated by those skilled in the art, many options may be used to define the portions of the paging zone that will receive the DOS and the portions that will receive a page. In a basic configuration, when the flood option is activated, all portions of the paging zone can transmit the DOS message. However, this option may be based on a flood criteria determination (e.g., 414), such as a designated time of day, the loading of the wireless system, the paging zone and the like. For example, the flood option may be used in rural paging zones where system loading is typically low. Likewise, the flood option may be used based on system loading or a designated time of day (e.g., 12 AM-6 AM) when system loading is expected to be low. Accordingly, even in systems with a flood option, the flood option may not be used. Further, the DOS message may be sent to less than all portions of the paging zone. Thus, the portions of the paging zone not receiving the DOS message can receive paging directed to the access terminal.

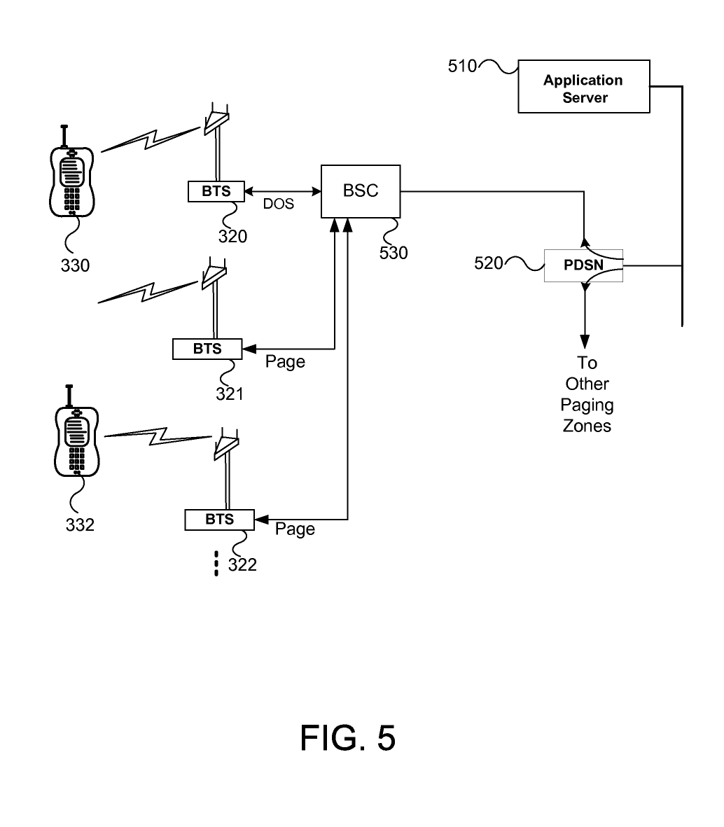

Referring to FIG. 5, a system diagram is illustrated in accordance with embodiments of the invention. For example, embodiments of the invention can include an apparatus including logic configured to generate a message for delivery via a wireless communication system and logic configured to send the message to the wireless communication system, wherein the message includes a request to send a data over signaling (DOS) message and page to an access terminal. For example, application server 510 can include all logic elements or the logic elements could be in one or more servers operably coupled to the wireless infrastructure.

Additionally, the apparatus may include logic configured to transmit the DOS message to the access terminal in a first portion of a paging zone estimated to contain the access terminal, and logic configured to page the access terminal in portions of the paging zone not receiving the DOS message. Once again the logic may be realized in one or more elements of the wireless infrastructure, such as BSC 530 and BTSs (e.g., 320-322). Likewise, the packet data serving node (PDSN) 520 can function in cooperation with the BSC 530 to receive the message from application server 510, decode a Type of Service field in the message and forward the appropriate directions to BSC 530.

Those skilled in the art will appreciate that typically many elements of the wireless infrastructure work cooperatively to provide services to and from the access terminals. Further, the functionality of each of the various elements could be relocated to other elements operably connected to the wireless system without changing the overall functionality. For example, the logic configured to transmit the DOS message to other portions of the paging zone, upon activation of a DOS flood option may include the BSC 530, BTSs (e.g., 320-322) in regard to the transmit function and other elements (e.g., remote servers/processors) operably coupled to the wireless infrastructure may be used in the determination of the activation of the flood option. Therefore, the invention is not limited to the illustrated configuration. Further, the discussion of system elements that may contain the functions of embodiments of the invention is merely for illustrative purposes and should not be construed to limit the embodiments of the invention.

As discussed in the foregoing, embodiments of the invention can improve system latency which can benefit all applications but is particularly important to delay sensitive applications. A group communication system is an example of a delay sensitive system that can take advantage of reduced connection times offered by the embodiments of the invention disclosed herein. The group communication system may also be known as a push-to-talk (PTT) system, a net broadcast service (NBS), a dispatch system, or a point-to-multi-point communication system. Typically, a group of access terminal users can communicate with one another using an access terminal assigned to each group member. The term “group member” denotes a group of access terminal users authorized to communicate with each other. Although, group communication systems/PTT systems may be considered to be among several members, the system is not limited to this configuration and can apply to communication between individual devices on a one to one basis.

The group may operate over an existing communications system, without requiring substantial changes to the existing infrastructure. Thus, a controller and users may operate in any system capable of transmitting and receiving packet information using Internet Protocol (IP), such as a Code Division Multiple Access (CDMA) system, a Time Division Multiple Access (TDMA) system, a Global System for Mobile Communications (GSM) system, satellite communication systems, combinations of land line and wireless systems, and the like.

Group members may communicate with each other using an assigned access terminal (AT), such as ATs 102, 108, and 112. The ATs may be wireline or wireless devices such as terrestrial wireless telephones, wireline telephones having push-to-talk capability, satellite telephones equipped with push-to-talk functionality, wireless video cameras, still cameras, audio devices such as music recorders or players, laptop or desktop computers, paging devices, or any combination thereof. Furthermore, each AT may be able to send and receive information in either a secure mode, or a non-secure (clear) mode. It should be understood that reference to an access terminal (AT) is not intended to be limited to the illustrated or enumerated examples, and may encompass other devices that have the capability to transmit and receive packet information in accordance with the Internet Protocol (IP).

When a group member wishes to transmit information to other members of the group, the member may request the transmission privilege by pressing a push-to-talk button or key on an AT, which generates a request formatted for transmission over a distributed network. For example using AT 102, the request may be transmitted over the air to one or more MPTs (or base stations) 124. A MPC/MSC 122, which may include a well-known inter-working function (IWF), packet data serving node (PDSN), or packet control function (PCF), for processing data packets may exist between MPT/BS 124 and the distributed network. However, the requests may also be transmitted through the public switched telephone network (PSTN) to a carrier network 126. The carrier network 126 may receive the request and provide it to the RAN for delivery to an access terminal.

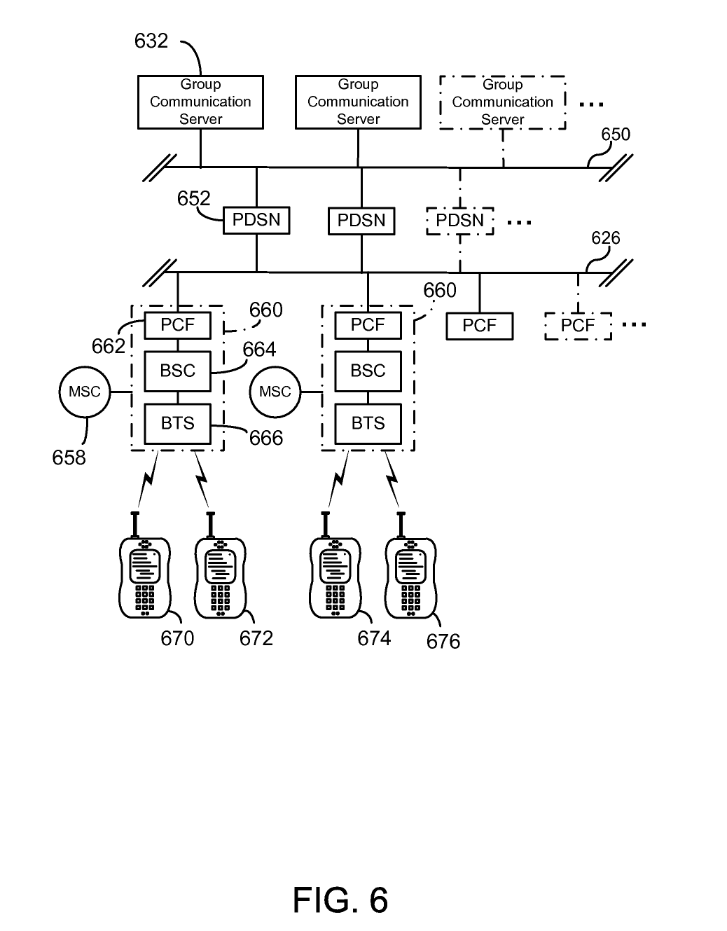

Referring to FIG. 6, one or more group communication servers 632 can monitor traffic of the group communication system through its connection to the distributed network. Since group communication server 632 can be connected to the distributed network through a variety of wired and wireless interfaces, geographic proximity to group participants is not necessary. Typically, a group communication server 632 controls communications between the wireless devices of group members (ATs 670, 672, 674, 676) in a PTT system. The wireless network illustrated is merely exemplary and can include any system whereby remote modules communicate over-the-air between and among each other and/or between and among components of a wireless network including, without limitation, wireless network carriers and/or servers. A series of group communication servers 632 can be connected to a group communication server LAN 650.

The group communication server(s) 632 can be connected to a wireless service provider's packet data service node (PDSN) such as PSDN 652, shown here resident on a carrier network 626. Each PSDN 652 can interface with a base station controller (BSC) 664 of a base station 660 through a packet control function (PCF) 662. The PCF 662 may be located in the base station 660. The carrier network 626 may control messages (generally in the form of data packets) sent to a MSC 658. The MSC 658 can be connected to one or more base stations 660. In a similar manner to the carrier network, the MSC 658 is typically connected to the base station transceiver (BTS) 666 by both the network and/or Internet for data transfer and PSTN for voice information. The BTS 666 ultimately broadcasts and receives messages wirelessly to and from the wireless ATs, such as cellular telephones 670, 672, 674, 676, as is well known in the art. Accordingly, the details of a group communication system will not be further discussed.

In at least one embodiment of the invention, a group communication server can include logic configured to generate a message for delivery via a wireless communication system and logic configured to send the message to the wireless communication system, wherein the message includes a request to send a data over signaling (DOS) message and page to an access terminal. The message sent can be used to establish a group call. The message can be sent in an Internet Protocol (IP) compatible format. Information instructing the wireless system to send both a DOS message and page the target access terminal can be included in a Type of Service (TOS) field. The message can be received at the wireless system and processed as discussed in the foregoing description. Accordingly, if the DOS message is received by the target access terminal, the PTT call can be established more rapidly than via paging alone. However, if the DOS message is not received by the target access terminal, the page directed to the access terminal will prevent the additional delay of waiting for the application layer to time out.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in single component. In the alternative, the processor and the storage medium may reside as discrete components.

Accordingly, an embodiment of the invention can include computer readable media embodying a method for reducing latency in a wireless communication system in accordance with the methods, algorithms, steps and/or functions disclosed herein. For example, an embodiment of the invention can include a computer-readable medium on which is stored a computer program for reducing latency in a wireless communication system. The computer program comprising instructions which, upon being executed, causes the computing device to perform a process of: transmitting a data over signaling (DOS) message to an access terminal in a first portion of a paging zone estimated to contain the access terminal and paging the access terminal in other portions of the paging zone.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method for reducing latency in a wireless communication system, the method comprising:
transmitting a data over signaling (DOS) message to an access terminal in a first portion of a paging zone estimated to contain the access terminal; and
paging the access terminal in other portions of the paging zone.

2. The method of claim 1, wherein the first portion is determined by the last communication from the access terminal.

3. The method of claim 1, wherein the DOS message and paging are generated in response to a message sent from an application server.

4. The method of claim 3, wherein the application server is a group communication server and the message sent is used to establish a group call.

5. The method of claim 3, wherein the message sent from the application server includes information to direct the wireless communication system to send both the DOS message and paging to the access terminal.

6. The method of claim 5, wherein the message sent from the application server is sent in an Internet Protocol (IP) compatible format.

7. The method of claim 5, wherein the information is included in a Type of Service (TOS) field.

8. The method of claim 1, further comprising:
receiving a response to at least one of the DOS message and pages sent to the access terminal.

9. The method of claim 8, further comprising:
sending the response to a source that generated a request to send the DOS message and paging.

10. The method of claim 1, further comprising:
resending the DOS message and paging sent to the access terminal after a predetermined time has elapsed.

11. A method for reducing latency in a wireless communication system, the method comprising:
generating a message for delivery via the wireless communication system; and
sending the message to the wireless communication system, wherein the message includes a request to send a data over signaling (DOS) message and page to an access terminal.

12. The method of claim 11, further comprising:
transmitting the DOS message to the access terminal in a first portion of a paging zone estimated to contain the access terminal; and
paging the access terminal in other portions of the paging zone.

13. The method of claim 11, further comprising:
transmitting the DOS message to the access terminal in a first portion of a paging zone estimated to contain the access terminal;
transmitting the DOS message to other portions of the paging zone, upon activation of a DOS flood option; and
paging the access terminal in portions of the paging zone not receiving the DOS message.

14. The method of claim 13, wherein the flood option is activated based on a flood criteria determination.

15. The method of claim 14, wherein the flood criteria determination includes at least one of a designated time of day, loading of the wireless system, and the paging zone.

16. The method of claim 13, wherein the DOS message is sent to less than all portions of the paging zone.

17. The method of claim 13, wherein the first portion is determined by the last communication from the access terminal.

18. The method of claim 13, wherein the DOS message and paging are generated in response to a message sent from an application server.

19. The method of claim 18, wherein the application server is a group communication server and the message sent is used to establish a group call.

20. The method of claim 18, wherein the message sent from the application server is sent in an Internet Protocol (IP) compatible format and the information is included in a Type of Service (TOS) field.

21. An apparatus comprising:
logic configured to generate a message for delivery via a wireless communication system; and
logic configured to send the message to the wireless communication system, wherein the message includes a request to send a data over signaling (DOS) message and page to an access terminal.

22. The apparatus of claim 21, further comprising:
logic configured to transmit the DOS message to the access terminal in a first portion of a paging zone estimated to contain the access terminal; and
logic configured to page the access terminal in other portions of the paging zone.

23. The apparatus of claim 21, further comprising:
logic configured to transmit the DOS message to the access terminal in a first portion of a paging zone estimated to contain the access terminal;
logic configured to transmit the DOS message to other portions of the paging zone, upon activation of a DOS flood option; and
logic configured to page the access terminal in portions of the paging zone not receiving the DOS message.

24. The apparatus of claim 23, wherein the flood option is activated based on a flood criteria determination.

25. The apparatus of claim 24, wherein the flood criteria determination includes at least one of a designated time of day, loading of the wireless system, and the paging zone.

26. The apparatus of claim 23, wherein the DOS message is sent to less than all portions of the paging zone.

27. The apparatus of claim 23, wherein the first portion is determined by the last communication from the access terminal.

28. The apparatus of claim 23, wherein the DOS message and pages are generated in response to a message sent from an application server.

29. The apparatus of claim 28, wherein the application server is a group communication server and the message sent is used to establish a group call.

30. The apparatus of claim 28, wherein the message sent from the application server is sent in an Internet Protocol (IP) compatible format and the information is included in a Type of Service (TOS) field.

31. A system comprising:
means for generating a message for delivery via a wireless communication system; and
means for sending the message to the wireless communication system, wherein the message includes a request to send a data over signaling (DOS) message and page to an access terminal.

32. The system of claim 31, further comprising:
means for transmitting the DOS message to the access terminal in a first portion of a paging zone estimated to contain the access terminal; and
means for paging the access terminal in other portions of the paging zone.

33. The system of claim 31, further comprising:
means for transmitting the DOS message to the access terminal in a first portion of a paging zone estimated to contain the access terminal;
means for transmitting the DOS message to other portions of the paging zone, upon activation of a DOS flood option; and
means for paging the access terminal in portions of the paging zone not receiving the DOS message.

34. The system of claim 33, wherein the flood option is activated based on a flood criteria determination.

35. The system of claim 33, wherein the DOS message is sent to less than all portions of the paging zone.

36. The system of claim 33, wherein the first portion is determined by the last communication from the access terminal.

37. The system of claim 33, wherein the DOS message and paging are generated in response to a message sent from an application server, and wherein the message sent from the application server is sent in an Internet Protocol (IP) compatible format and the information is included in a Type of Service (TOS) field.

38. A computer readable media embodying a method for reducing latency in a wireless communication system, the method comprising:
transmitting a data over signaling (DOS) message to an access terminal in a first portion of a paging zone estimated to contain the access terminal; and
paging the access terminal in other portions of the paging zone.

39. The computer readable media of claim 38, wherein the first portion is determined by the last communication from the access terminal.

40. The computer readable media of claim 38, wherein the DOS message and paging are generated in response to a message sent from an application server and wherein the message sent from the application server includes information to direct the wireless communication system to send both the DOS message and paging to the access terminal.
